(19) United States
(12) Patent Application Publication
(10) Pub. No.: US 2016/0163102 A1
(43) Pub. Date: Jun. 9, 2016

(54) COMPUTING DEVICE AND METHOD FOR PROCESSING POINT CLOUDS

(71) Applicants: Fu Tai Hua Industry (Shenzhen) Co., Ltd., Shenzhen (CN); HON HAI PRECISION INDUSTRY CO., LTD., New Taipei (TW)

(72) Inventors: CHIH-KUANG CHANG, New Taipei (TW); XIN-YUAN WU, Shenzhen (CN); ZHE-RUI WEI, Shenzhen (CN); PENG XIE, Shenzhen (CN)

(21) Appl. No.: 14/689,754

(22) Filed: Apr. 17, 2015

(30) Foreign Application Priority Data
Dec. 5, 2014 (CN) 201410731449.5

(51) Int. Cl. G06T 17/20; G06T 15/10; G06T 7/00

(52) U.S. Cl. CPC G06T 17/205; G06T 7/0034; G06T 15/10; G06T 7/0081; G06T 2207/10028; G06T 2210/56; G06T 2207/20076; G06T 2210/12

(57) ABSTRACT

A computing device and a method of processing point clouds of an object. Two groups of point clouds are selected as a first and a second group of point clouds. Redundant points in the first and second groups of point clouds are determined and marked using a first indicator. Normal points are determined in the second group of point clouds and marked using a second indicator. The method further uses a plurality of cubes for dividing the redundant points marked with the first indicator, and clears a first indicator of a specified redundant point in each of cubes which has a minimum distance to a centre point of the each of cubes. The method merges points which have not been marked with the first indicators in the first and second groups of point clouds to be a new group of point clouds.

### CROSS-REFERENCE TO RELATED APPLICATIONS

This application claims priority to Chinese Patent Application No. 201410731449.5 filed on Dec. 5, 2014, the contents of which are incorporated by reference herein.

### FIELD

The subject matter herein relates to point cloud technology, and particularly to a computing device and a method for processing point clouds of an object.

### BACKGROUND

A plurality of groups of point clouds of an object scanned by a scanner can be merged to be a new group of point clouds which have a higher precision. The new group of point clouds can be meshed for obtaining a point cloud model. However, there are a lot of redundant points among the plurality of groups of point clouds. If the redundant points are not filtered from the plurality of groups of point clouds, the new group of point clouds cannot be meshed efficiently and precisely.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of an example embodiment of a computing device.

FIG. 2 is a block diagram of an example embodiment of a point cloud processing system in the computing device of FIG. 1.

FIG. 3 is a flowchart of an example embodiment of a method for processing point clouds.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts can be exaggerated to better illustrate details and features. The description is not to be considered as limiting the scope of the embodiments described herein.

Several definitions that apply throughout this disclosure will now be presented. The term “module” refers to logic embodied in computing or firmware, or to a collection of software instructions, written in a programming language, such as, Java, C, or assembly. One or more software instructions in the modules can be embedded in firmware, such as in an erasable programmable read only memory (EPROM). The modules described herein can be implemented as either software and/or computing modules and can be stored in any type of non-transitory computer-readable medium or other storage device. Some non-limiting examples of non-transitory computer-readable media include CDs, DVDs, BLU-RAY™, flash memory, and hard disk drives. The term “comprising” means “including, but not necessarily limited to”; it specifically indicates open-ended inclusion or membership in a so-described combination, group, series and the like.

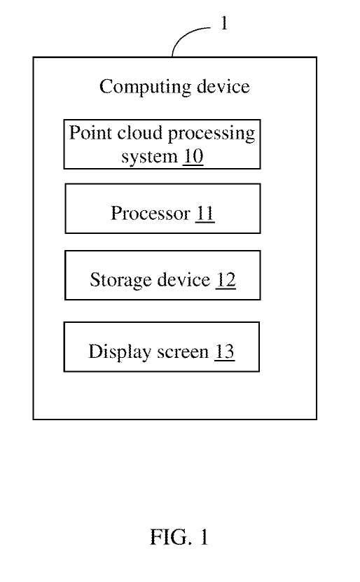

FIG. 1 illustrates a block diagram of an example embodiment of a computing device. In at least one embodiment as shown in FIG. 1, a computing device 1 can include, but is not limited to, a point cloud processing system 10, at least one processor 11, a storage device 12, and a display screen 13. The computing device 1 can be a computer, a server, or other suitable device. The at least one processor 11 executes one or more computerized codes and other applications of the computing device 1 to provide functions of the computing device 1. The storage device 12 can be an internal storage device, such as a random access memory (RAM) for temporary storage of information, and/or a read only memory (ROM) for permanent storage of information. The storage device 12 can also be an external storage device, such as an external hard disk, a storage card, or a data storage medium. The display screen 13 can display data of the computing device 1.

In at least one embodiment, the storage device 12 can store a plurality of point cloud files of an object (e.g., a workpiece) which require to be merged. FIG. 1 illustrates only one example of the computing device 1, and other examples can comprise more or fewer components than those shown in the embodiment, or have a different configuration of the various components. In at least one embodiment, the point cloud processing system 10 can merge the plurality of groups of point clouds precisely by filtering redundant points in the plurality of groups of point clouds.

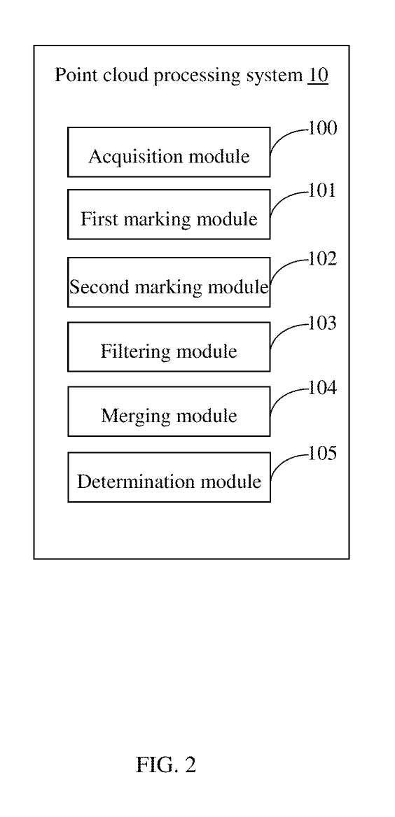

FIG. 2 illustrates a block diagram of an example embodiment of the point cloud processing system in the computing device. In at least one embodiment, the point cloud processing system 10 can include, but is not limited to, an acquisition module 100, a first marking module 101, a second marking module 102, a filtering module 103, a merging module 104, and a determination module 105. The modules 100-105 can include computerized instructions in the form of one or more computer-readable programs that can be stored in a non-transitory computer-readable medium, such as the storage device 12, and be executed by the at least one processor 11 of the computing device 1.

The acquisition module 100 acquires a plurality of groups of point clouds of an object from the storage device 12, and selects two groups of point clouds as a first group of point clouds and a second group of point clouds. The acquisition module 100 can acquire the groups of point clouds by reading a plurality of point cloud files, which are stored in the storage device 12 and are required to be merged. The acquisition module 100 can further display the first group of point clouds and the second group of point clouds on the display screen 13.

The first marking module 101 determines redundant points in the first group of point clouds and in the second group of point clouds, and marks each of the redundant points using a first indicator (e.g., a number “0”). In at least one embodiment, the first marking module 101 determines a first bounding box of the first group of point clouds by calculating a minimum X coordinate value and a maximum X coordinate value, a minimum Y coordinate value and a maximum Y coordinate value, and a minimum Z coordinate value and a maximum Z coordinate value from coordinates values of the first group of point clouds based on a predetermined coordinate system. The first marking module 101 further determines a second bounding box of the second group of point clouds by calculating a minimum X coordinate value and a maximum X coordinate value, a minimum Y coordinate value and a maximum Y coordinate value, and a minimum Z coordinate value and a maximum Z coordinate value from coordinates values of the second group of point clouds.

The first marking module 101 further calculates an overlapping area between the first bounding box and the second bounding box. If the overlapping area has no point both in the first group of point clouds and the second group of point clouds, the first marking module 101 determines that there is no redundant points in the first group of point clouds and the second group of point clouds, and the first group of point clouds and the second group of point clouds can be merged to be a new group of point clouds directly. If the overlapping area has one or more points both in the first group of point clouds and the second group of point clouds, the first marking module 101 determines that the one or more points in the overlapping area are the redundant points and marks the redundant points using the first indicator.

The second marking module 102 determines normal points in the second group of point clouds and marks each of the normal points using a second indicator (e.g., with a number “1”). A minimum distance between each of the normal points and points in the first group of point clouds is greater than a preset distance. In at least one embodiment, the second marking module 102 can calculate distances between each point in the second group of point clouds and the points in the first group of point clouds, and determines a minimum distance corresponding to each point in the second group of point clouds. If the minimum distance corresponding to one point is greater than the preset distance, the second marking module 102 determines the point to be the normal point and marks the normal point with the second indicator.

It should be understood that, if one point marked with the first indicator (e.g., one redundant point) in the second group of point clouds is further determined to be the normal point, that is, the determination of the redundant point needs to be corrected, the second marking module 102 uses the second indicator to replace the first indicator for indicating that the point is the normal point, but not the redundant point. In other embodiments, the second marking module 102 can clear the first indicator of the redundant point which is determined to be the normal point, in the second group of point clouds. After the second marking module 102 marks the normal points in the second group of point clouds, the redundant points in the second group of point clouds can be rechecked.

The filtering module 103 uses a plurality of cubes to divide a max bounding box of the redundant points marked with the first indicator in the first and the second groups of point clouds according to a cube segmentation method, and clears a first indicator of a specified redundant point in each of the plurality of cubes which has a minimum distance to a centre point of each of the plurality of cubes. In at least one embodiment, the filtering module 103 extracts a minimum X coordinate value “Xₘᵢₙ” and a maximum X coordinate value “Xₘₐₓ”, a minimum Y coordinate value “Yₘᵢₙ” and a maximum Y coordinate value “Yₘₐₓ”, and a minimum Z coordinate value “Zₘᵢₙ” and a maximum Z coordinate value “Zₘₐₓ” from coordinate values of the redundant points. The filtering module 103 further determines a side length “L” of a minimum bounding cube of the redundant points by an equation of “L=max((Xₘₐₓ−Xₘᵢₙ), (Yₘₐₓ−Yₘᵢₙ), (Zₘₐₓ−Zₘᵢₙ))”. The filtering module 103 confirms a minimum distance “Lₘᵢₙ” between each two points of the redundant points according to an equation of “Lₘᵢₙ≈³\sqrt{L³/n}”, and “n” represents a number of redundant points. The minimum distance “Lₘᵢₙ” is determined to be a minimum side length of each of the cubes. By dividing the max bounding box of the redundant points using the plurality of cubes having the minimum side length “Lₘᵢₙ”, each cube can include at least one redundant point.

In at least one embodiment, after the filtering module 103 divides the max bounding box of the redundant points using the plurality of cubes having the minimum side length “Lₘᵢₙ”, the filtering module 103 selects one point “V (Xᵥ, Yᵥ, Zᵥ)” from the redundant points as a vertex point, and calculates a centre point O (X₀, Y₀, Z₀) of the corresponding cube which includes the point “V (Xᵥ, Yᵥ, Zᵥ)”. The coordinates of the centre point O (X₀, Y₀, Z₀) can be represented by equations of

$$“ {X}_{o} = {X}_{v} + \frac{{L}_{min}}{2} ” , \\ “ {Y}_{o} = {Y}_{v} + \frac{{L}_{min}}{2} ” , \\ and$$

$$“ {Z}_{o} = {Z}_{v} + \frac{{L}_{min}}{2} ” .$$

According to the above equations, the filtering module 103 can calculate coordinate values of centre points of all of the plurality of cubes. The filtering module 103 further calculates a distance between each redundant point included in each cube and the centre point of the each cube according to a preset distance formula (e.g., an Euler distance formula of “Dis=\sqrt{(Δx)²+(Δy)²+(Δz)²}”). The filtering module 103 determines a specified redundant point which has the minimum distance to the centre point of the each cube, and clears the first indicator of the specified redundant point. The specified redundant point is regarded to be the normal point, but not the redundant point. In other embodiments, the filtering module 103 can also use the second indicator to replace the first indicator of the specified redundant point in each cube, for indicating that the specified redundant point is not the redundant point.

In at least one embodiment, in order to manage the plurality of cubes, the filtering module 103 creates a linked list “list[M][N][W]” according to numbers of the cubes on an X axis, Y axis and Z axis which are represented by

$$“ M = \frac{Δ X}{{L}_{min}} ” , \\ “ N = \frac{Δ Y}{{L}_{min}} ” , \\ and$$

$$“ W = \frac{Δ Z}{{L}_{min}} ” ,$$

A structure array can be created according to the linked list and preset index values (e.g., coordinates) of each of the redundant points. For example, members of the structure array can include suffix of each of the redundant points and suffix of a corresponding cube which includes the redundant point. Using the structure array, each cube can be related to one or more redundant points included in the cube.

The merging module 104 merges points which have not been marked with the first indicators in the first group of point clouds and in the second group of point clouds to be a new group of point clouds. In at least one embodiment, the merging module 104 checks the indicators of all of points in the first group of point clouds and in the second group of point clouds, discards the points marked with the first indicator from the first group of point clouds and the second group of point clouds, and inserts the points marked with the second indicator and the points having no indicator in the new group of point clouds. That is, the new group of point clouds includes the points marked with the second indicator or the points having no indicator.

The determination module 105 determines whether all of the plurality of groups of point clouds have been selected. If there is at least one group of point clouds that has not been selected, the acquisition module 100 determines the new group of point clouds as an updated first group of point clouds and determines one unselected group of point clouds as an updated second group of point clouds to be merged, until all of the acquired groups of point clouds of the object have been merged to generate new precise point clouds of the object.

In other embodiment, after the maximum bounding box of the redundant points marked with the first indicator is divided by cubes, not only is the first indicator of the specified redundant point in each cube cleared or replaced by the second indicator which has the minimum distance to the centre point of the each cube, but also the redundant points included in each cube except the specified redundant point are deleted. Therefore, a data merging procedure of the first group of point clouds and the second group of point clouds can be simplified.

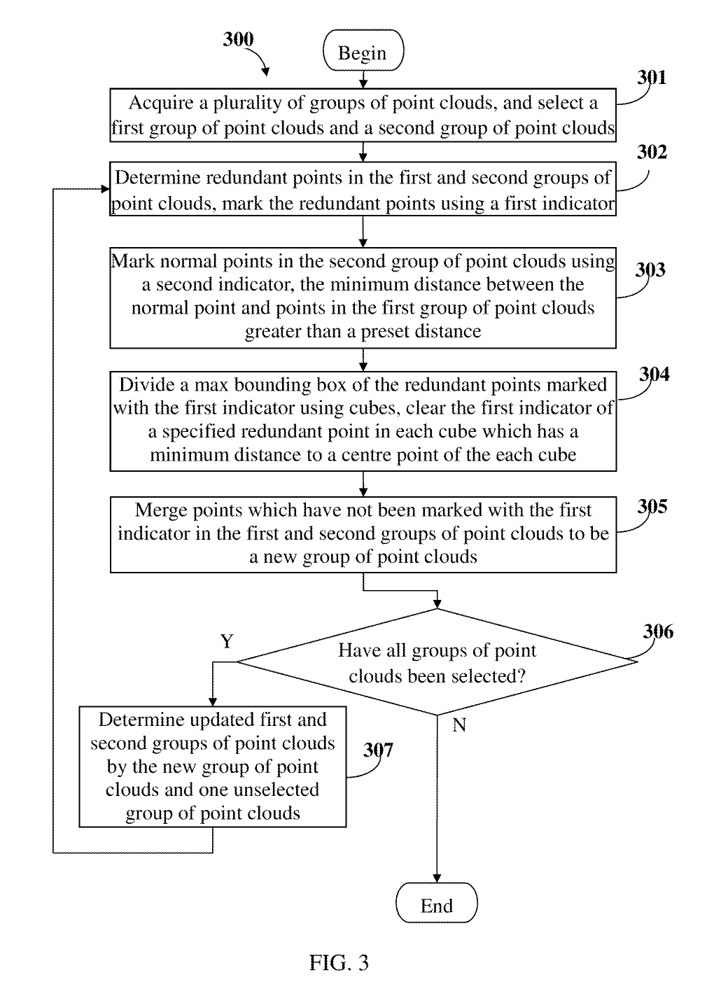

FIG. 3 illustrates a flowchart of an example embodiment of a method for processing point clouds. In an example embodiment, the method is performed by execution of computer-readable software program codes or instructions by at least one processor of a computing device.

Referring to FIG. 3, a flowchart is presented in accordance with an example embodiment. An example method 300 is provided by way of example, as there are a variety of ways to carry out the method. The example method 300 described below can be carried out using the configurations illustrated in FIGS. 1-2, for example, and various elements of these figures are referenced in explaining the example method 300. Each block shown in FIG. 3 represents one or more processes, methods, or subroutines, carried out in the method example 300. Furthermore, the illustrated order of blocks is illustrative only and the order of the blocks can be changed. Additional blocks can be added or fewer blocks can be utilized without departing from this disclosure. The example method 300 can begin at block 301.

At block 301, an acquisition module acquires a plurality of groups of point clouds of an object from the storage device 12, and selects two groups of point clouds as a first and second group of point clouds. The acquisition module can acquire the groups of point clouds by reading a plurality of point cloud files, which are stored in the storage device 12 to be merged. The acquisition module can further display the first group of point clouds and the second group of point clouds on the display screen 13.

At block 302, a first marking module determines redundant points in the first group of point clouds and in the second group of point clouds, and marks each of the redundant points using a first indicator (e.g., with a number of “0”). In at least one embodiment, the first marking module 101 determines a first bounding box of the first group of point clouds by calculating a minimum X coordinate value and a maximum X coordinate value, a minimum Y coordinate value and a maximum Y coordinate value, and a minimum Z coordinate value and a maximum Z coordinate value from coordinates values of the first group of point clouds based on a predetermined coordinate system. The first marking module 101 further determines a second bounding box of the second group of point clouds by calculating a minimum X coordinate value and a maximum X coordinate value, a minimum Y coordinate value and a maximum Y coordinate value, and a minimum Z coordinate value and a maximum Z coordinate value from coordinates values of the second group of point clouds.

In at least one embodiment, the first marking module further calculates an overlapping area between the first bounding box and the second bounding box. If the overlapping area has no point in both the first group of point clouds and the second group of point clouds, it represents that there is no redundant points in the first group of point clouds and the second group of point clouds, and the first group of point clouds and the second group of point clouds can be merged to be a new group of point clouds directly, block 306 can be implemented. If the overlapping area has one or more points both in the first group of point clouds and the second group of point clouds, the points in the overlapping area are determined to be redundant points and the first marking module 101 marks each of the redundant points using the first indicator.

At block 303, a second marking module determines normal points in the second group of point clouds, and marks each of the normal points using a second indicator (e.g., with a number of “1”). A minimum distance between each of the normal points and points in the first group of point clouds is greater than a preset distance. In at least one embodiment, the second marking module can calculate distances between each point in the second group of point clouds and the points in the first group of point clouds, and determines a minimum distance corresponding to each point in the second group of point clouds. If the minimum distance corresponding to one point is greater than the preset distance, the second marking module determines the point to be the normal point and the second marking module marks the normal point using the second indicator.

It should be understood that, if one point marked with the first indicator (e.g., one redundant point) in the second group of point clouds is determined to be the normal point, it represents that the determination of the redundant point needs to be corrected, the second marking module 102 uses the second indicator to replace the first indicator for indicating that the point is the normal point, but not the redundant point. In other embodiments, the second marking module 102 can clear the first indicator of the redundant point which is determined to be the normal point in the second group of point clouds. After the second marking module marks the normal points in the second group of point clouds, the redundant points in the second group of point clouds can be rechecked.

At block 304, a filtering module uses a plurality of cubes to divide a max bounding box of the redundant points marked with the first indicator in the first and the second group of point clouds according to a cube segmentation method method, and clears a first indicator of a specified redundant point in each of the plurality of cubes which has a minimum distance to a central point of each of the plurality of cubes. In at least one embodiment, the filtering module extracts a minimum X coordinate value “Xₘᵢₙ” and a maximum X coordinate value “Xₘₐₓ”, a minimum Y coordinate value “Yₘᵢₙ” and a maximum Y coordinate value “Yₘₐₓ”, and a minimum Z coordinate value “Zₘᵢₙ” and a maximum Z coordinate value “Zₘₐₓ” from coordinate values of the redundant points and determines a side length “L” of a minimum bounding cube of the redundant points by an equation of “L=max((Xₘₐₓ−Xₘᵢₙ), (Yₘₐₓ−Yₘᵢₙ), (Zₘₐₓ−Zₘᵢₙ))”. The filtering module 103 confirms a minimum distance “Lₘᵢₙ” between each two redundant points in according to an equation of “Lₘᵢₙ≈³·\sqrt{L³/n}”, and “n” represents a number of the redundant points. The minimum distance “Lₘᵢₙ” is determined to be a minimum side length of each of the cubes. By dividing the max bounding box of the redundant points using the plurality of cubes having the minimum side length “Lₘᵢₙ”, each cube can include at least one redundant point.

In at least one embodiment, after the filtering module 103 divides the max bounding box of the redundant points using the plurality of cubes having the minimum side length “Lₘᵢₙ”, the filtering module selects a point “V (Xᵥ, Yᵥ, Zᵥ)” from the redundant points as a vertex point, and calculates an centre point O (X₀, Y₀, Z₀) of the corresponding cube which includes the point “V (Xᵥ, Yᵥ, Zᵥ)”. The coordinates of the centre point O (X₀, Y₀, Z₀) can be represented by equations of

$$“ {X}_{o} = {X}_{v} + \frac{{L}_{min}}{2} ” , \\ “ {Y}_{o} = {Y}_{v} + \frac{{L}_{min}}{2} ” , \\ “ {Z}_{o} = {Z}_{v} + \frac{{L}_{min}}{2} ” .$$

According to the above equations, the filtering module can calculate coordinate values of centre points for all of the plurality of cubes. The filtering module further calculates a distance between each point included in each cube and the centre point of the each cube according to a preset distance formula (e.g., an Euler distance formula of “Dis=\sqrt{(Δx)²+(Δy)²+(Δz)²}”). The filtering module determines a specified redundant point which has the minimum distance from the centre point of the each cube, and clears the first indicator of the specified redundant point. The specified redundant point is regarded as the normal point, but not the redundant point. In other embodiments, the filtering module can also use the second indicator to replace the first indicator of the determined a redundant point with the minimum distance from the centre point of the corresponding cube, for indicating that the specified redundant point is not the redundant point.

At block 305, a merging module merges points which have not been marked with the first indicators in the first group of point clouds and in the second group of point clouds to be a new group of point clouds. In at least one embodiment, the merging module checks the indicators of all of points in the first group of point clouds and in the second group of point clouds, discards the points marked with the first indicator, and inserts the points marked with the second indicator and the points having no indicator in the new group of point clouds.

At block 306, a determination module determines whether all of the plurality of groups of point clouds have been selected. If there is at least one group of point clouds not selected, block 307 is implemented. If all of the acquired groups of point clouds have been selected to be merged, the procedure ends.

At block 307, the acquisition module determines the new group of point clouds as an updated first group of point clouds and continuously selects one unselected group of point clouds as an updated second group of point clouds to be merged, and block 302 is implemented.

All of the processes described above can be embodied in, and fully automated via, functional code modules executed by one or more general purpose processors such as the processor 11. The code modules can be stored in any type of non-transitory readable medium or other storage device such as the storage device 12. Some or all of the methods can alternatively be embodied in specialized hardware. Depending on the embodiment, the non-transitory readable medium can be a hard disk drive, a compact disc, a digital versatile disc, a tape drive, or other storage medium.

The described embodiments are merely examples of implementations, and have been set forth for a clear understanding of the principles of the present disclosure. Variations and modifications can be made without departing substantially from the spirit and principles of the present disclosure. All such modifications and variations are intended to be included within the scope of this disclosure and the described inventive embodiments, and the present disclosure is protected by the following claims and their equivalents.

What is claimed is:

1. A computing device comprising:
at least one processor; and
a storage device connected to the at least one processor and storing one or more programs executable by the at least one processor to cause the at least one computer processor to:
acquire, from the storage device, a plurality groups of point clouds of an object;
select two groups of point clouds as a first group of point clouds and a second group of point clouds;
merge the first group of point clouds and the second group of point clouds by:
determining redundant points in both the first group of point clouds and the second group of point clouds, and marking each of the redundant points using a first indicator;
determining normal points in the second group of point clouds and marking each of the normal points using a second indicator, a minimum distance between each of the normal points and points in the first group of point clouds being greater than a preset distance;
using a plurality of cubes to divide a max bounding box of the redundant points marked with the first indicator according to a cube segmentation method, and clearing a first indicator of a specified redundant point in each of the plurality of cubes, the specified redundant point having a minimum distance to a central point of each of the plurality of cubes;
merging points, which have not been marked with the first indicators in the first group of point clouds and in the second group of point clouds, into a new group of point clouds.

2. The computing device of claim 1, wherein the at least one processor further:
determines whether all of the plurality of groups of point clouds have been selected;
when there is at least one group of point clouds has not been selected, determines the new group of point clouds to be an updated first group of point clouds and one unselected group of point clouds to be an updated second group of point clouds and executes the merging method based on the updated first group of point clouds and the updated second group of point clouds until all of the plurality of groups of point clouds have been selected.

3. The computing device of claim 1, wherein the redundant points in the first group of point clouds and in the second group of point clouds are determined by:
determining a first bounding box of the first group of point clouds by calculating a minimum X coordinate value and a maximum X coordinate value, a minimum Y coordinate value and a maximum Y coordinate value, and a minimum Z coordinate value and a maximum Z coordinate value from coordinates values of the first group of point clouds based on a predetermined coordinate system;
determining a second bounding box of the second group of point clouds by calculating a minimum X coordinate value and a maximum X coordinate value, a minimum Y coordinate value and a maximum Y coordinate value, and a minimum Z coordinate value and a maximum Z coordinate value from coordinates values of the second group of point clouds;
calculating an overlapped area between the first bounding box and the second bounding box; and
if the overlapped area has no point both in the first group of point clouds and the second group of point clouds, determining that there is no redundant point in the first group of point clouds and the second group of point clouds, and merging the first group of point clouds and the second group of point clouds to be the new group of point clouds; or
if the overlapped area has one or more points both in the first group of point clouds and the second group of point clouds, determining the one or more points in the overlapped area to be the redundant points.

4. The computing device of claim 1, wherein each of the plurality of cubes of dividing the max bounding box has a minimum side length, and the minimum side length is calculated by:
extracting a minimum X coordinate value “Xₘᵢₙ” and a maximum X coordinate value “Xₘₐₓ”, a minimum Y coordinate value “Yₘᵢₙ” and a maximum Y coordinate value “Yₘₐₓ”, and a minimum Z coordinate value “Zₘᵢₙ” and a maximum Z coordinate value “Zₘₐₓ” from coordinate values of the redundant points;
determining a side length “L” of a minimum bounding cube of the redundant points according to an equation of “L=max((Xₘₐₓ−Xₘᵢₙ), (Yₘₐₓ−Yₘᵢₙ), (Zₘₐₓ−Zₘᵢₙ))”; and
confirming the minimum distance “Lₘᵢₙ” between two points in the redundant point according to an equation of “Lₘᵢₙ≈³\sqrt{L³/n}”, n representing a number of the redundant points.

5. The computing device of claim 1, wherein the points in the first group of point clouds and in the second group of point clouds are merged by:
discarding the points marked with the first indicator, and inserting the points marked with the second indicator and the points having no indicator in the new group of point clouds.

6. The computing device of claim 1, when one point marked with the first indicator in the second group of point clouds is determined to be the normal point, wherein the at least one processor uses the second indicator to replace the first indicator of the point or clears the first indicator of the point for indicating that the point is not the redundant point.

7. A computer-based method for processing point clouds using a computing device, being executed by at least one processor of the computing device, the method comprising:
acquiring a plurality groups of point clouds of an object from a storage device of the computing device, and selecting two groups of point clouds as a first group of point clouds and a second group of point clouds;
determining redundant points in both the first group of point clouds and the second group of point clouds, and marking each of the redundant points using a first indicator;
determining normal points in the second group of point clouds and marking each of the normal points using a second indicator, a minimum distance between each of the normal points and points in the first group of point clouds being greater than a preset distance;
using a plurality of cubes to divide a max bounding box of the redundant points marked with the first indicator according to a cube segmentation method, and clearing a first indicator of a specified redundant point in each of the plurality of cubes, the specified redundant point having a minimum distance to a centre point of each of the plurality of cubes;
merging points, which have not been marked with the first indicators in the first group of point clouds and in the second group of point clouds, to be a new group of point clouds.

8. The method of claim 7, further comprising:
determining whether all of the plurality of groups of point clouds have been selected;
when there is at least one group of point clouds of the acquired groups of point clouds has not been selected, determining the new group of point clouds as the updated first group of point clouds and one unselected group of point clouds to be an updated second group of point clouds.

9. The method of claim 7, wherein the redundant points in the first group of point clouds and in the second group of point clouds are determined by:
determining a first bounding box of the first group of point clouds by calculating a minimum X coordinate value and a maximum X coordinate value, a minimum Y coordinate value and a maximum Y coordinate value, and a minimum Z coordinate value and a maximum Z coordinate value from coordinates values of first group of point clouds based on a predetermined coordinate system;
determining a second bounding box of the second group of point clouds by calculating a minimum X coordinate value and a maximum X coordinate value, a minimum Y coordinate value and a maximum Y coordinate value, and a minimum Z coordinate value and a maximum Z coordinate value from coordinates values of the second group of point clouds;
calculating an overlapped area between the first bounding box and the second bounding box;
if the overlapped area has no point both in the first group of point clouds and the second group of point clouds, determining that there is no redundant point in the first group of point clouds and the second group of point clouds and merging the first group of point clouds and the second group of point clouds being merged to be the new group of point clouds;
if the overlapped area has one or more points both in the first group of point clouds and the second group of point clouds, determining the one or more points in the overlapped area to be the redundant points.

10. The method of claim 7, wherein each of the plurality of cubes of dividing the max bounding box has a minimum side length, and the minimum side length is calculated by:
extracting a minimum X coordinate value “Xₘᵢₙ” and a maximum X coordinate value “Xₘₐₓ”, a minimum Y coordinate value “Yₘᵢₙ” and a maximum Y coordinate value “Yₘₐₓ”, and a minimum Z coordinate value “Zₘᵢₙ” and a maximum Z coordinate value “Zₘₐₓ” from coordinate values of the redundant points;
determining a side length “L” of a minimum bounding cube of the redundant points by an equation of “L=max((Xₘₐₓ−Xₘᵢₙ), (Yₘₐₓ−Yₘᵢₙ), (Zₘₐₓ−Zₘᵢₙ))”;
confirming the minimum distance “Lₘᵢₙ” between two points in the redundant points according to an equation of “Lₘᵢₙ≈³\sqrt{L³/n}”, n representing a number of the redundant points.

11. The method of claim 7, wherein the points in the first group of point clouds and in the second group of point clouds are merged by:
discarding the points marked with the first indicator, and inserting the points marked with the second indicator and the points having no indicator in the new group of point clouds.

12. The method of claim 7, wherein the method further comprises:
when one point marked with the first indicator in the second group of point clouds is determined to be the normal point, using the second indicator to replace the first indicator of the point or clears the first indicator of the point for indicating that the point is not the redundant point.

13. A non-transitory computer-readable medium having stored thereon instructions that, when executed by at least one processor of a computing device, causing the computing device to perform a method for processing point clouds, the method comprising:
acquiring a plurality groups of point clouds of an object from a storage device of the computing device, and selecting two groups of point clouds as a first group of point clouds and a second group of point clouds;
determining redundant points both in the first group of point clouds and the second group of point clouds, and marking each of the redundant points using a first indicator;
determining normal points in the second group of point clouds and marking each of the normal points using a second indicator, a minimum distance between each of the normal points and points in the first group of point clouds being greater than a preset distance;
using a plurality of cubes to divide a max bounding box of the redundant points marked with the first indicator according to a cube segmentation method, and clearing a first indicator of a specified redundant point in each of the plurality of cubes, the specified redundant point having a minimum distance to a centre point of each of the plurality of cubes;
merging points, which have not been marked with the first indicators in the first group of point clouds and in the second group of point clouds, to be a new group of point clouds.

14. The non-transitory computer-readable medium of claim 13, wherein the method further comprising:
determining whether all of the plurality of groups of point clouds have been selected;
when there is at least one group of point clouds of the acquired groups of point clouds has not been selected, determining the new group of point clouds as the updated first group of point clouds and one unselected group of point clouds to be merged.

15. The non-transitory computer-readable medium of claim 13, wherein the redundant points in the first group of point clouds and in the second group of point clouds are determined by:
determining a first bounding box of the first group of point clouds by calculating a minimum X coordinate value and a maximum X coordinate value, a minimum Y coordinate value and a maximum Y coordinate value, and a minimum Z coordinate value and a maximum Z coordinate value from coordinates values of first group of point clouds based on a predetermined coordinate system;
determining a second bounding box of the second group of point clouds by calculating a minimum X coordinate value and a maximum X coordinate value, a minimum Y coordinate value and a maximum Y coordinate value, and a minimum Z coordinate value and a maximum Z coordinate value from coordinates values of the second group of point clouds;
calculating an overlapped area between the first bounding box and the second bounding box;
if the overlapped area has no point both in the first group of point clouds and the second group of point clouds, determining that there is no redundant point in the first group of point clouds and the second group of point clouds and merging the first group of point clouds and the second group of point clouds being merged to be the new group of point clouds;
if the overlapped area has one or more points both in the first group of point clouds and the second group of point clouds, determining the one or more points in the overlapped area to be the redundant points.

16. The non-transitory computer-readable medium of claim 13, wherein each of the plurality of cubes of dividing the max bounding box has a minimum side length, and the minimum side length is calculated by:
extracting a minimum X coordinate value “Xₘᵢₙ” and a maximum X coordinate value “Xₘₐₓ”, a minimum Y coordinate value “Yₘᵢₙ” and a maximum Y coordinate value “Yₘₐₓ”, and a minimum Z coordinate value “Zₘᵢₙ” and a maximum Z coordinate value “Zₘₐₓ” from coordinate values of the redundant points;
determining a side length “L” of a minimum bounding cube of the redundant points by an equation of “L=max((Xₘₐₓ−Xₘᵢₙ), (Yₘₐₓ−Yₘᵢₙ), (Zₘₐₓ−Zₘᵢₙ))”;
confirming the minimum distance “Lₘᵢₙ” between two points in the redundant points according to an equation of “Lₘᵢₙ≈³\sqrt{L³/n}”, n representing a number of the redundant points.

17. The non-transitory computer-readable medium of claim 13, wherein the points in the first group of point clouds and in the second group of point clouds are merged by:
discarding the points marked with the first indicator, and inserting the points marked with the second indicator and the points having no indicator in the new group of point clouds.

18. The non-transitory computer-readable medium of claim 13, wherein the method further comprises:
when one point marked with the first indicator in the second group of point clouds is determined to be the normal point, using the second indicator to replace the first indicator of the point or clears the first indicator of the point for indicating that the point is not the redundant point.
